(19) United States
(12) Patent Application Publication
(10) Pub. No.: US 2015/0102903 A1
(43) Pub. Date: Apr. 16, 2015

(54) Secure Delivery Receptacle

(71) Applicant: Wal-Mart Stores, Inc., Bentonville, AR (US)

(72) Inventor: Bruce W. Wilkinson, Rogers, AR (US)

(73) Assignee: Wal-Mart Stores, Inc., Bentonville, AR (US)

(21) Appl. No.: 14/052,102

(22) Filed: Oct. 11, 2013

(51) Int. Cl. G07C 9/00

(52) U.S. Cl. CPC G07C 9/00111
USPC 340/5.61

(57) ABSTRACT

A secure-delivery receptacle includes a delivered-package vault having a selectively-lockable access portal controlled, at least in part, by a control circuit that also operably couples to a radio-frequency identification (RFID)-tag reader. The RFID-tag reader serves, by one approach, to read RFID tags in the immediate vicinity of the delivered-package vault. So configured, the control circuit can, for example, verify a delivery-vector RFID tag (such as an RFID tag uniquely associated with a given delivery person) and responsively unlock the selectively-lockable access portal. Also so configured, the control circuit can verify when at least one expected package RFID tag is placed within the delivered-package vault to confirm delivery of a corresponding expected package (by, for example, sending one or more messages to the intended recipient, the delivery service, the shipping party, and so forth).

### TECHNICAL FIELD

This invention relates generally to delivery receptacles.

### BACKGROUND

Delivery receptacles are known in the art. Residential and business postal service mailboxes are one example in these regards. In some cases the mailbox is an unsecured container into which a letter carrier places delivered mail. In other cases a keyed lock secures the container, with both the letter carrier and the recipient having a corresponding key. Legal restrictions typically prohibit non-postal service delivery services from using mailboxes when making their deliveries. In any event, unsecured containers may be inappropriate for many delivery purposes and typical mailbox sizes are often inadequate to accommodate a wide variety of delivered items.

Other delivery receptacles have been proposed from time to time to provide a viable option for non-postal service delivery services. Unfortunately, developments to date have been at least partially inadequate in terms of meeting the needs of any of a wide variety of possible application settings.

### BRIEF DESCRIPTION OF THE DRAWINGS

The above needs are at least partially met through provision of the secure delivery receptacle described in the following detailed description, particularly when studied in conjunction with the drawings, wherein:

FIG. 1 comprises a block diagram as configured in accordance with various embodiments of the invention;

FIG. 2 comprises a schematic perspective representation as configured in accordance with various embodiments of the invention;

FIG. 3 comprises a schematic view as configured in accordance with various embodiments of the invention; and

FIG. 4 comprises a flow diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a secure-delivery receptacle includes a delivered-package vault having a selectively-lockable access portal controlled, at least in part, by a control circuit that also operably couples to a radio-frequency identification (RFID)-tag reader. The RFID-tag reader serves, at least in part, to read RFID tags in the immediate vicinity of the delivered-package vault. So configured, the control circuit can, for example, verify a pre-authorized delivery-vector RFID tag (such as an RFID tag uniquely associated with a given delivery person) and responsively unlock the selectively-lockable access portal. Also so configured, the control circuit can verify when at least one expected package RFID tag is placed within the delivered-package vault to confirm delivery of a corresponding expected package (by, for example, sending one or more messages to the intended recipient, the delivery service, the shipping party, and so forth).

By one approach, both the delivery person and each of the delivered packages have a corresponding RFID tag. The delivery person may have an identification badge, for example, that includes their personal RFID tag. By associating each package with a unique corresponding RFID tag it becomes possible to employ this secure-delivery receptacle to take any number of useful actions in response to detecting the placement of expected packages in the delivered-package vault.

These teachings are highly flexible in practice and will accommodate a wide variety of variations and embellishments. As one example, the secure-delivery receptacle can include a closed-portal detector that operably couples to the control circuit to detect and verify when the selectively-lockable access portal is open and closed. In such a case, for example, the control circuit can be configured to know when the delivered-package vault has been closed following a complete delivery of expected packages therein (as detected, for example, via the RFID-tag reader) and to then respond by, for example, providing a unique human-perceptible cue to verify for the delivery person the proper execution of the delivery process.

As another example, the secure-delivery receptacle can further include a wireless communication interface (other than the aforementioned RFID-tag reader) that operably couples to the control circuit and that permits the latter to receive messages, for example, providing details regarding expected deliveries (such as a unique number associated with the delivery person's RFID tag and/or the unique numbers associated with the RFID tags associated with each package to be delivered). So configured, the control circuit can readily receive information that will be useful when determining, for example, whether to unlock the selectively-lockable access portal and whether an expected package has been placed within the delivered-package vault. The control circuit can also employ such a wireless communication interface to transmit delivery acknowledgements and notices and so forth.

As yet another example the secure-delivery receptacle can further include a video component configured to facilitate making an image-based record of packages being placed inside the delivered-package vault. Such a visual record can well serve the interests of all parties to the delivery.

And as yet another example in these regards, the secure-delivery receptacle can further include a temperature sensor that operably couples to the control circuit to thereby provide the latter with information regarding the temperature within the delivered-package vault. So configured, for example, the control circuit can provide a notification (to, for example, the intended recipient or other caretaker) regarding delivered packages as a function, at least in part, of that sensed temperature. This approach can help the recipient to avoid disappointment that might occur upon leaving perishable, cold items in the secure-delivery receptacle for too long when the interior temperature is too high.

These and many other approaches can serve to facilitate meeting essentially any unattended-delivery application setting. So configured, a person or business can feel more secure when making delivery orders, knowing that the delivered items are more likely to be properly delivered, secured, and protected than in the past.

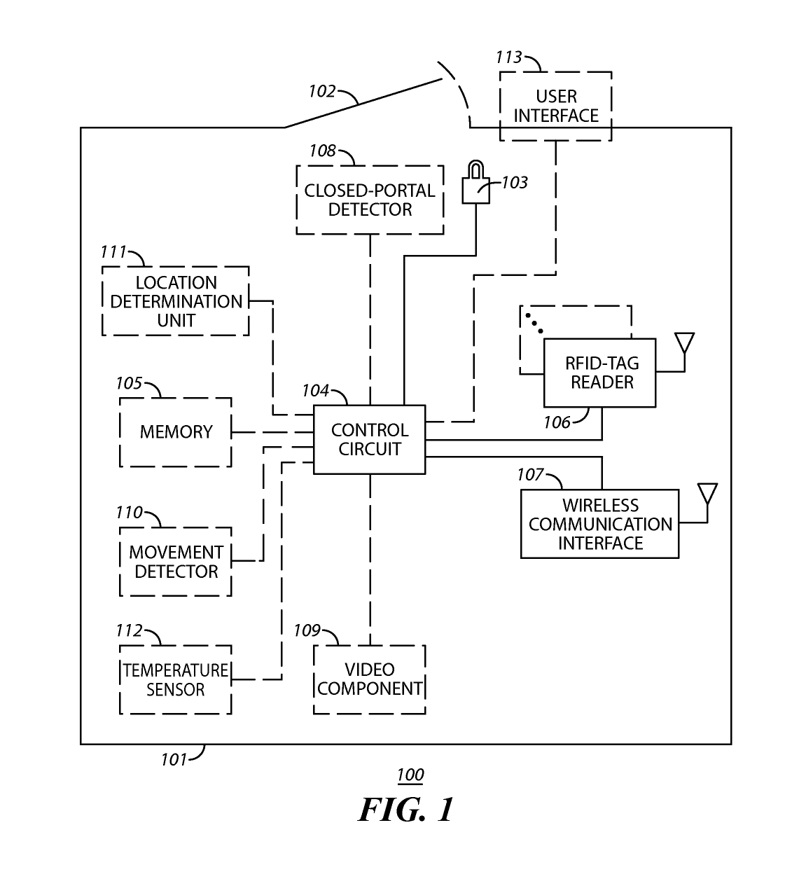

These and other benefits may become clearer upon making a thorough review and study of the following detailed description. Referring now to the drawings, and in particular to FIG. 1, an illustrative example of a secure-delivery receptacle 100 that accords with many of these teachings will now be presented.

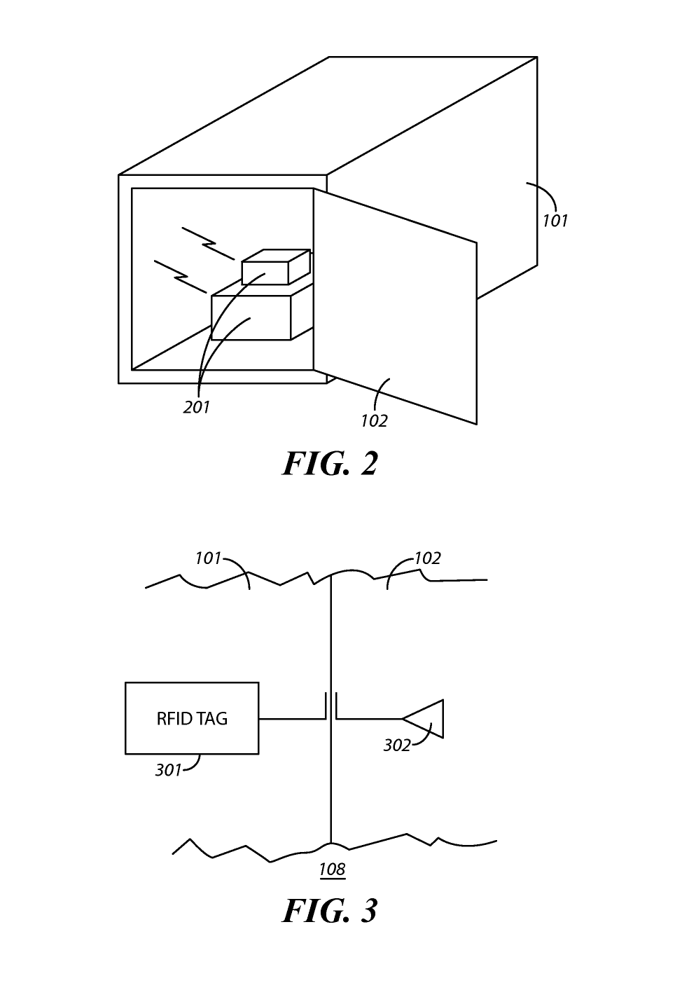

In this example the secure-delivery receptacle 100 includes at least one delivered-package vault 101 having at least one selectively-lockable access portal 102. The delivered-package vault 101 can assume any of a wide variety of form factors including any of a variety of differently-proportioned and differently-sized rectangles. By way of example and without intending any limitations in these regards, FIG. 2 illustrates a delivered-package vault 101 having a rectangular shape.

Similarly, the delivered-package vault 101 can be comprised of any of a variety of materials include various metals, impact-resistant plastics, and so forth. The particular shape, size, and material employed in a given application can vary depending upon the needs and requirements of that application setting. As one simple example in these regards, when the secure-delivery receptacle 100 is intended to receive a plurality of grocery parcels as corresponds to, say, a week's worth of groceries, the delivered-package vault 101 can comprise a rectangle having an interior space of between 10 to 16 cubic feet.

The selectively-lockable access portal 102 can similarly have any of a variety of sizes and shapes as desired. By one approach (and as shown in the illustrative example presented in FIG. 2) the selectively-lockable access portal 102 comprises one or more doors that are pivotally secured to a front (or side or top) panel of the delivered-package vault 101 and that is of sufficient size to cover an opening through that panel that is itself of sufficient size to permit ready access to the interior of the delivered-package vault 101 to thereby facilitate the placement of delivered packages 201 therein and the subsequent removal of such packages 201 by the recipient.

A locking mechanism 103 of choice permits this door to be selectively locked and unlocked by, for example, a control circuit 104 to which the locking mechanism 103 is operably coupled or to which the locking mechanism 103 is otherwise remotely responsive. A variety of known locking mechanisms are known in the art that will suffice in these regards including, for example, locking mechanisms that employ an electrically-controlled latch.

The aforementioned control circuit 104 can comprise a fixed-purpose hard-wired platform or can comprise a partially or wholly programmable platform. These architectural options are well known and understood in the art and require no further description here. This control circuit 104 is configured (for example, by using corresponding programming as will be well understood by those skilled in the art) to carry out one or more of the steps, actions, and/or functions described herein.

By one approach the control circuit 104 operably couples to an optional memory 105. This memory 105 may be integral to the control circuit 104 or can be physically discrete (in whole or in part) from the control circuit 104 as desired. This memory 105 can also be local with respect to the control circuit 104 (where, for example, both share a common circuit board, chassis, power supply, and/or housing) or can be partially or wholly remote with respect to the control circuit 104.

This memory 105 can serve, for example, to non-transitorily store the computer instructions that, when executed by the control circuit 104, cause the control circuit 104 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The secure-delivery receptacle 100 also includes one or more RFID-tag readers 106 that also operably couple to the control circuit 104. Such RFID-tag readers are known in the art and serve to read RFID tags. These so-called tags often assume the form factor of a label or a literal “tag” but are also sometimes integrated with a host article and/or its packaging. RFID tags typically comprise an integrated circuit and one or more antennas. The integrated circuit typically carries out a variety of functions including modulating and demodulating radio frequency signals, data storage, and data processing. Some integrated circuits are active or self-powered (in whole or in part) while others are passive, being completely dependent upon an external power source (such as received power from the RFID tag reader) to support their occasional functionality.

By one approach the RFID-tag reader 106 is located and configured to reliably read RFID tags that are disposed within the delivered-package vault 101. By another approach, in lieu of the foregoing or in combination therewith, there is an RFID-tag reader 106 located and configured to reliably read an RFID tag that is located externally to the delivered-package vault 101 (such as, for example, an RFID tag carried by a delivery person to identify themselves when making a delivery).

By one approach a single RFID-tag reader 106 can serve in both such regards by attaching to and employing more than one antenna. Using this approach, for example, a near-field antenna configuration can be mounted on the outside of the delivered-package vault 101 to read RFID tags presented by delivery personnel and one or more far-field antenna configurations can be disposed within the interior of the delivered-package vault 101 to read RFID tags on packages that are placed therein.

By one approach this RFID-tag reader 106 is configured to read RFID tags that provide unique corresponding identification numbers. The Electronic Product Code (EPC) as managed by EPCGlobal, Inc. represents one example in these regards. EPC-based RFID tags each have an utterly-unique serial number (within the EPC system) to thereby uniquely identify each tag and, by association, each item associated on a one-for-one basis with such tags. (The corresponding document entitled EPC Radio-Frequency Identity Protocols Class-1 Generation-2 UHF RFID Protocol for Communications at 860 MHz-960 MHz Version 1.0.9 (often referred to as “EPC GEN2”) is hereby fully incorporated herein by this reference.)

For many application settings it is useful for the control circuit 104 to have communicative connectivity that enables communications with remotely-located entities (such as delivery services, shipping entities, recipients, and so forth). If desired a non-wireless approach will serve in these regards (such as any of a variety of electrical or optical conductors that are known in the art). As illustrated in the present example a wireless communication interface 107 of choice that operably couples to the control circuit 104 serves in these regards. Any of a variety of short-range, medium-range, and long-range systems will suffice in these regards including, for example, any of a variety of wireless telephony systems.

So configured, the control circuit 104 can receive (via, for example, the wireless communications interface 107) information regarding any impending delivery. Such information can include, for example, a specified time window during which the delivery should occur along with the unique RFID-tag identification numbers for an RFID tag carried by the delivery person to identify and verify themselves and for RFID tags for each package to be delivered into the secure-delivery receptacle 100. As described below, the control circuit 104 can use this pre-approval information to authenticate the delivery person before unlocking the selectively-lockable access portal 102 and to detect and then confirm placement of the expected packages within the delivered-package vault.

By one optional approach the secure-delivery receptacle 100 further includes a closed-portal detector 108 that serves to detect when the selectively-lockable access portal 102 is closed (or, conversely, opened). This closed-portal detector 108 operably couples to the control circuit 104 and hence serves to inform the latter as regards the opened/closed state of the selectively-lockable access portal 102.

By one approach, and referring momentarily to FIG. 3, the closed-portal detector 108 can comprise an RFID tag 301 that mounts to the interior of the delivered-package vault 101 and an RFID-tag antenna 302 that mounts to an inner surface of the selectively-lockable access portal 102. When the door is closed the latter may operably couple to the former, for example, by way of inductive coupling or by way of a physical electrical contact as desired. So configured, when the selectively-lockable access portal 101 is closed the RFID tag 301 is operably coupled to the antenna 302 and hence able to respond to the RFID-tag reader 106 with, for example, its own identification information. Conversely, when the selectively-lockable access portal 101 is not closed, the connection between the RFID tag 301 and the antenna 302 breaks and the RFID tag 301 becomes unable to meaningfully respond to the RFID-tag reader 106. So configured, the ability of the RFID tag 301 to respond to a read request by the RFID-tag reader 106 becomes, in and of itself, a telltale that the selectively-lockable access portal 101 is closed. Such an approach represents very little incremental cost and further leverages the availability of the RFID-tag reader 106.

By one approach these teachings will further accommodate an optional video component 109 configured to facilitate making an image-based record of packages being placed inside the delivered-package vault 101. This video component 109 can comprise, as desired, a video-only component or can comprise a video/audio component that will capture both images and sound. Various video components are known in the art and the present teachings are not particularly sensitive to the selection of any particular approach. Depending upon the application setting and/or the requirements of the user, the video component can use as high, or as low, resolution as desired, can be color or non-color, can employ any desired frame rate, and so forth as desired.

By one approach, that video component 109 is mounted towards the rear of the delivered-package vault 101 and is aimed towards the front thereof in order to capture images of packages as such packages are placed in the delivered-package vault 101. These teachings will also accommodate, if desired, using more than one video component in order to capture different fields of view. These teachings will also accommodate configuring the video component (or one of many available video components) to capture external views (such as of the delivery person approaching and/or interacting with the secure-delivery receptacle 100).

If desired, the video component 109 can be configured to rotate, pan, and/or zoom under the control of the control circuit 104 to thereby permit the latter to automatically track, for example, movement. Also if desired, one or more light sources (including visible light and infrared light sources) can be provided to illuminate part or all of the field of view for the video component 109.

By one approach, the control circuit 104 is configured to respond, for example, to the opening of the closed-portal detector 108 by automatically activating the video component 109 and to closing of the closed-portal detector 108 by automatically deactivating the video component 109. Captured video (and/or audio) can be stored, for example, in the aforementioned memory 105 and/or streamed (live or on-demand) via the aforementioned wireless communication interface 107 as desired.

By one approach (and with continued reference to FIG. 1) the secure-delivery receptacle 100 can further optionally include a movement detector 110. This movement detector 110 can be configured to detect movement within the delivered-package vault 101 and/or external thereto as desired. This movement detector 110 (or detectors) can also be operably coupled to the control circuit 104. So configured, and as one illustrative example, the control circuit 104 can respond to the detection of movement by activating the video component 109. There are various other ways by which the control circuit 104 can use detected-movement information if desired. For example, by one approach the movement detector 110 can serve as a tamper detector, and hence the movement detector 110 can serve to detect when an unauthorized person is aggressively trying to gain unauthorized access to the delivered-package vault 101 or is, for example, attempting to move or is moving the delivered-package vault 101 from an installed location.

By one approach the secure-delivery receptacle 100 further optionally includes a location determination unit 111 (such as, but not limited to, a global position system (GPS) receiver as is well known in the art). This location determination unit 111 can again be operably coupled to the control circuit 104. So configured, and as one illustrative example, upon determining that the location of the secure-delivery receptacle 100 is changing the control circuit 104 can automatically transmit alarms and alerts via the wireless communication interface 107 to alert authorized persons in those regards. The control circuit 104 could also transmit present location information as determined by the location determination unit 111 to help authorized persons locate and retrieve the secure-delivery receptacle 100.

By yet another approach the secure-delivery receptacle 100 can further optionally include one or more temperature sensors 112. Such a temperature sensor 112 could be located, for example, inside the delivered-package vault 101 and can be operably coupled to the control circuit 104. So configured, the control circuit 104 could determine when the interior temperature of the delivered-package vault 101 is too hot (or cold) for a delivered package contained within the delivered-package vault 101 and automatically respond, for example, by transmitting a corresponding alert (via, for example, the wireless communication interface 107). As another example the interior temperature of the delivered-package vault 101 could help the control circuit 104 employ a corresponding climate control system (such as a heater and/or air conditioner) to maintain an appropriate interior temperature.

When each delivered package has a corresponding unique RFID tag, and the control circuit 104 has sufficient information to correlate such tags to specific contents (or at least to categorical statements regarding the contents, such as “perishable” or “keep cool”), the control circuit 104 can use such information to help govern its responses to such temperature information. For example, when the delivered-package vault 101 is empty, or when a delivered package is essentially impervious to a higher temperature that might otherwise be troubling to a perishable item, the control circuit 104 can determine to not take any particular responsive action notwithstanding an elevated interior temperature because that elevated temperature does not represent a troubling state given present circumstances.

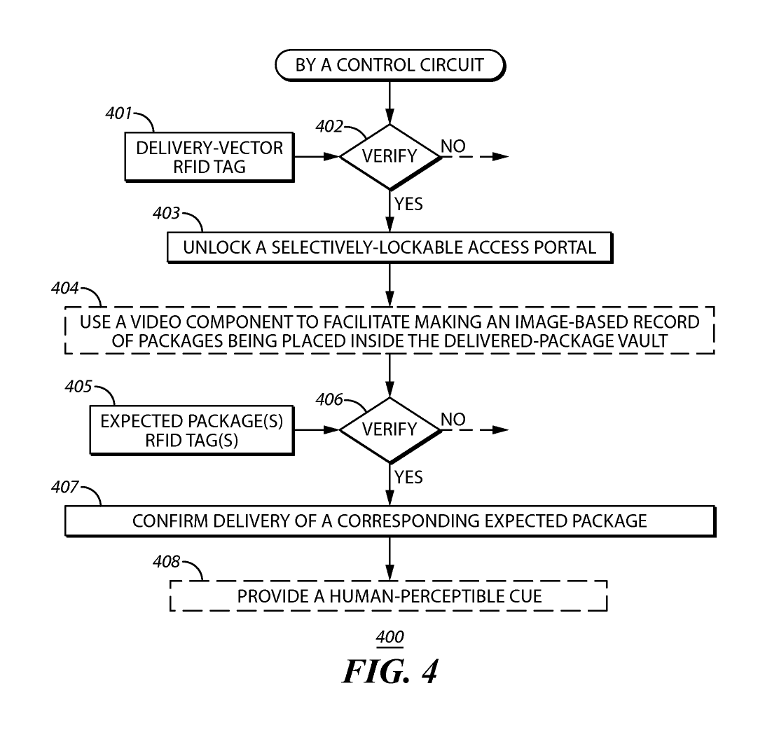

FIG. 4 illustrates various ways that such a secure-delivery receptacle 100 can serve. In particular, FIG. 4 presents a process 400 that can be carried out, in whole or in part, by a control circuit 104 as described above.

By one approach, for example, the control circuit 104 can receive (via the wireless communication interface 107) a message regarding a pending delivery. That message can include information regarding, for example, a time of day and/or a window of time during which the delivery is scheduled to occur, information (such as a unique identification number) regarding a delivery-vector RFID tag (such as a name/identification badge for the delivery person who is scheduled to make the delivery), and information regarding the specifics of the delivery itself (such as, but not limited to, identification numbers for RFID tags that are associated with each package along with specific or general identification of the items being delivered).

In such a case, the delivery person can present their identification badge to the RFID-tag reader 106 and the control circuit 104 can then verify (at decision block 402) that the expected RFID-tag identification number for the delivery person 401 matches the proffered RFID tag. Upon verifying the foregoing the control circuit 104 can then, for example, automatically unlock (at block 403) the selectively-lockable access portal 102 to permit the delivery person to access the interior of the delivered-package vault 101. (By one approach, the control circuit 104 may be configured to so verify a particular delivery-vector RFID tag only provided that the RFID tag is presented within no more than a predetermined period of time following receipt of the aforementioned wireless message and/or within a predetermined period of time as measured from a target delivery time as specified in such a wireless message.)

That verification can also serve, if desired, to trigger (at block 404) automatic use of the video component 109 to facilitate making an image-based record of packages being placed inside the delivered-package vault 101. As another approach in these regards, in lieu of the foregoing or in combination therewith the activation of the video component 109 can be based, at least in part, upon the monitored state of the selectively-lockable access portal 102 (as determined, for example, via the aforementioned closed-portal detector 108).

Somewhat similarly, the control circuit 104 can further employ the RFID-tag reader 109 to read RFID tags for packages as those packages are placed inside the delivered-package vault 101 and to compare the information in those read tags (such as their unique identification numbers) with previously-received information regarding the expected packages RFID tags 405. Upon verifying (at block 406) appropriate matches in those regards the control circuit 104 can, for example, confirm delivery (at block 407) of the corresponding expected package(s). This confirmation can comprise, for example, transmitting confirmation messages via the aforementioned wireless communication interface 107 to the delivery service, the intended recipient, the enterprise that shipped the package, and so forth.

If desired, this process 400 will further optionally accommodate (at block 408) providing a human-perceptible cue to alert the delivery person of particular events such as delivery of all expected packages and/or that the delivery person has securely closed the selectively-lockable access portal 102 following having placed all expected packages in the delivered-package vault 101. This human-perceptible cue can be provided via, for example, a user interface 113 (as shown in FIG. 1) that operably couples to the control circuit 104. This user interface 113 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user such as the aforementioned human-perceptible cue (which may comprise, for example, a visual cue such as a flashing light or the display of a particular icon or text message and/or an audible cue such as a particular tone, melody, or spoken message that conveys the appropriate information).

These teachings are highly flexible in practice. As but one example in these regards, the aforementioned control circuit 104 can be configured to (only) assume an active state (as describe above) in response to receiving a particular message via the wireless communication interface 106.

The apparatus can receive electrical power via any of a variety of means including through a wired connection to a local mains and/or via a native capability to convert solar energy into electrical power as desired.

So configured, a wide variety of goods can be readily and securely delivered to a given recipient without requiring that the recipient be available at the time of delivery. These teachings leverage the use of RFID tags in a variety of ways to provide a high degree of security and quality assurance that exceeds the results achieved with numerous prior art attempts in these regards at very favorable price points.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. As but one illustrative example in these regards, if desired and in lieu of the foregoing or in combination therewith the control circuit 104 can be configured to unlock the locking mechanism 103 in response to receiving a corresponding unlock signal via the wireless communication interface 107. Such a capability would permit, for example, the recipient to permit a friend to drop something off without requiring the use of any RFID tags. The friend could, for example, call or text the recipient to say “I am here” (or the like) and the recipient could then contact the control circuit 104 via a mobile phone, computer, pad, or the like to cause the latter to unlock the secure-delivery receptacle 100.

What is claimed is:

1. An apparatus comprising:
a delivered-package vault having a selectively-lockable access portal;
a radio-frequency identification (RFID)-tag reader;
a control circuit operably coupled to the RFID-tag reader and the selectively-lockable access portal and configured to verify when at least one expected package RFID tag is placed within the delivered-package vault to confirm delivery of a corresponding expected package.

2. The apparatus of claim 1 wherein the apparatus further comprises a user output operably coupled to the control circuit and wherein the control circuit is further configured to provide a human-perceptible cue upon verifying placement of the expected package RFID tag in the delivered-package vault.

3. The apparatus of claim 2 wherein the control circuit is further configured to provide a unique human-perceptible cue upon verifying placement of a plurality of expected package RFID tags in the delivered-package vault.

4. The apparatus of claim 2 further comprising:
a closed-portal detector operably coupled to the control circuit;
wherein the control circuit is further configured to provide a unique human-perceptible cue upon verifying closure of the selectively-lockable access portal following a complete delivery of a plurality of expected packages into the delivered-package vault.

5. The apparatus of claim 4 wherein the closed-portal detector comprises, at least in part, an RFID tag that can only be read by the RFID-tag reader when the selectively-lockable access portal is closed.

6. The apparatus of claim 1 further comprising:
a wireless communication interface, other than the RFID-tag reader, operably coupled to the control circuit.

7. The apparatus of claim 6 wherein the control circuit is further configured to verify a delivery-vector RIFD tag and unlock the selectively-lockable access portal in response to such verification, only upon receiving a wireless message via the wireless communication interface that pre-authorizes the delivery-vector RFID tag.

8. The apparatus of claim 7 wherein the control circuit is further configured to only verify the delivery-vector RFID tag when the delivery-vector RFID tag is presented within no more than a predetermined period of time following receipt of the wireless message.

9. The apparatus of claim 6 wherein the control circuit is further configured to receive RFID-tag information regarding the expected package RFID tag via the wireless communication interface.

10. The apparatus of claim 6 wherein the control circuit is further configured to provide delivery information to at least one of a delivery service and a delivery recipient.

11. The apparatus of claim 6 wherein the control circuit is further configured to assume an active state in response to receiving a particular message via the wireless communication interface.

12. The apparatus of claim 1 further comprising:
a video component configured to facilitate making an image-based record of packages being placed inside the delivered-package vault.

13. The apparatus of claim 12 wherein the control circuit is further configured to control the making of the image-based record as a function, at least in part, of a monitored state of the selectively-lockable access portal.

14. The apparatus of claim 1 further comprising:
a temperature sensor operably coupled to the control circuit and disposed within the delivered-package vault;
wherein the control circuit is further configured to provide notifications regarding a delivered package in the delivered-package vault as a function, at least in part, of temperatures within the delivered-package vault as sensed by the temperature sensor.

15. A method comprising:
by a control circuit that is operably coupled to a radio-frequency identification (RFID)-tag reader:
using the RFID-tag reader to verify a delivery-vector RIFD tag and unlock a selectively-lockable access portal in response to such verification;
using the RFID-tag reader to verify when at least one expected package RFID tag is placed within a delivered-package vault to confirm delivery of a corresponding expected package.

16. The method of claim 15 further comprising:
providing a human-perceptible cue upon verifying placement of the expected package RFID tag in the delivered-package vault.

17. The method of claim 15 further comprising:
providing a unique human-perceptible cue upon verifying closure of the selectively-lockable access portal following a complete delivery of a plurality of expected packages into the delivered-package vault.

18. The method of claim 15 wherein verifying a delivery-vector RIFD tag comprises only verifying the delivery-vector RFID tag in response to having previously received a wireless message as regards the delivery-vector RFID tag.

19. The method of claim 15 further comprising:
providing delivery information to at least one of a delivery enterprise and a delivery recipient.

20. The method of claim 15 further comprising:
using a video component to facilitate making an image-based record of packages being placed inside the delivered-package vault.
